(19) United States
(12) Patent Application Publication
(10) Pub. No.: US 2010/0077301 A1
(43) Pub. Date: Mar. 25, 2010

(54) SYSTEMS AND METHODS FOR ELECTRONIC DOCUMENT REVIEW

(75) Inventors: David Bodnick, New York, NY (US); Eli Gild, Mountain View, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Applied Discovery, Inc.

(21) Appl. No.: 12/563,795

(22) Filed: Sep. 21, 2009

Related U.S. Application Data
(60) Provisional application No. 61/099,033, filed on Sep. 22, 2008.

(51) Int. Cl. G06F 17/00

(52) U.S. Cl. 715/274

(57) ABSTRACT

There is provided a computer-executable method for ordering documents for review in response to an electronic discovery request. The method involves determining, by a processor, one or more metrics of the documents, the one or more metrics indicating at least one of privilege and responsiveness of the documents. The method also involves estimating a relevancy of the documents according to the metrics. The method also involves ordering the documents from most relevant to least relevant according to the relevancy, receiving relevance feedback from a first document reviewer, updating the order according to the relevance feedback, and sending a first subset of the updated ordered documents to a second document reviewer for review.

### I. RELATED APPLICATIONS

This application claims priority from U.S. Provisional Patent Application No. 61/099,033, filed Sep. 22, 2008, entitled “Systems and Methods for Electronic Document Review,” the entire contents of which are hereby incorporated by reference.

### II. TECHNICAL FIELD

The present disclosure generally relates to the field of electronic document review. More particularly, the disclosure relates to computer-based systems and methods for increasing an efficiency of electronic document review.

### BACKGROUND INFORMATION

In electronic document review, reviewers from a litigation team review large numbers of documents in one or more electronic formats. The documents that are reviewed are organized according to a particular scheme. There are two traditional schemes for organizing and ordering the documents.

In a first approach, the documents are ordered either randomly, or according to a field. The field describes characteristics of the documents, such as a document custodian, creation date, or edit date, etc. However, even when documents are ordered according to a field, the ordering of documents within the field is random. Because of their random ordering, it may be difficult or time consuming for the reviewers to locate or identify an important document. Therefore, the litigation team may not locate the important document in a timely manner.

In a second approach, a semi-automated system identifies and removes documents that are not relevant. In this approach, the semi-automated system may automatically delete the documents that it deems to be irrelevant. Alternatively, the semi-automated system may group together the documents that it deems to be irrelevant, to allow an administrator to delete these documents. Regardless, these systems are often highly complicated. Moreover, in these systems, interesting or important documents may be overlooked. Therefore, document productions created by these systems may expose a client to legal challenges and may be inadmissible in court.

In addition to ordering, electronic document review also involves assigning documents to different reviewers. Traditionally, litigation teams use a manual approach for document assignment. Specifically, an administrator manually assigns the documents to reviewers, and manually determines which documents to assign to which reviewers. In this approach, quality control is also manual. The manual nature of the assignments is time consuming, and therefore, expensive.

### SUMMARY

Disclosed systems and methods may order documents for electronic document review. For example, disclosed embodiments may determine a relevancy of the documents, and may order the documents by the determined relevancy. Moreover, disclosed systems and methods may also assign documents to reviewers for electronic document review. For example, disclosed embodiments may group the documents by category, and send the grouped documents to a reviewer with expertise in the category.

Consistent with a disclosed embodiment, a computer-executable method is provided ordering documents for review in response to an electronic discovery request, the method comprising: determining, by a processor, one or more metrics of the documents, the one or more metrics indicating at least one of privilege and responsiveness of the documents; estimating a relevancy of the documents according to the metrics; ordering the documents from most relevant to least relevant according to the relevancy; receiving relevance feedback from a first document reviewer; updating the order according to the relevance feedback; and sending a first subset of the updated ordered documents to a second document reviewer for review.

Consistent with a disclosed embodiments, a system is provided for ordering documents for review in response to an electronic discovery request, the system comprising: a processor configured to: determine one or more metrics of the documents, the one or more metrics indicating at least one of privilege and responsiveness of the documents; estimate a relevancy of the documents according to the metrics; and order the documents from most relevant to least relevant according to the relevancy; an input port configured to receive relevance feedback from a first document reviewer, wherein the processor is further configured to update the order according to the relevance feedback; and an output port configured to send a first subset of the updated ordered documents to a second document reviewer for review.

Consistent with a disclosed embodiment, a computer-executable method is provided for assigning an un-reviewed document to a reviewer in response to an electronic discovery request, the method comprising: identifying first metrics that characterize the un-reviewed document; receiving feedback from a reviewer about a reviewed document; determining, after receiving the feedback, that the reviewer efficiently reviews documents that are characterized by the first metrics; assigning, by a processor, the document to the reviewer according to the received feedback; and sending the document to the assigned reviewer for review based at least on receiving a document distribution command.

Consistent with a disclosed embodiment, a system is provided for assigning an un-reviewed document to a reviewer in response to an electronic discovery request, the system comprising: a processor configured to: identify first metrics that characterize the un-reviewed documents; an input port configured to receive feedback from a reviewer about a reviewed document, wherein the processor is further configured to determine, after receiving the received feedback, that the reviewer efficiently reviews documents that are characterized by the first metrics, and assign the document to the reviewer according to the received feedback; and an output port configured to send the document to the assigned reviewer for review based at least on receiving a document distribution command.

It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this disclosure, illustrate various embodiments. In the drawings:

FIG. 1 is an example of a system for electronic document review, consistent with a disclosed embodiment;

FIG. 2 is a flow diagram of an exemplary process for document ordering in a electronic document review, consistent with a disclosed embodiment;

FIG. 3 is a flow diagram of an exemplary process for assigning documents for electronic review, consistent with a disclosed embodiment; and

FIG. 4 is a flow diagram of an exemplary process for analyzing an electronic document, consistent with a disclosed embodiment.

### DETAILED DESCRIPTION

The following detailed description refers to the accompanying drawings. Wherever possible, the same reference numbers are used in the drawings and the following description to refer to the same or similar parts. While several exemplary embodiments are described herein, modifications, adaptations and other implementations are possible. For example, substitutions, additions, or modifications may be made to the components illustrated in the drawings, and the exemplary methods described herein may be modified by substituting, reordering, deleting, or adding steps to the disclosed methods. Accordingly, the following detailed description is not limiting.

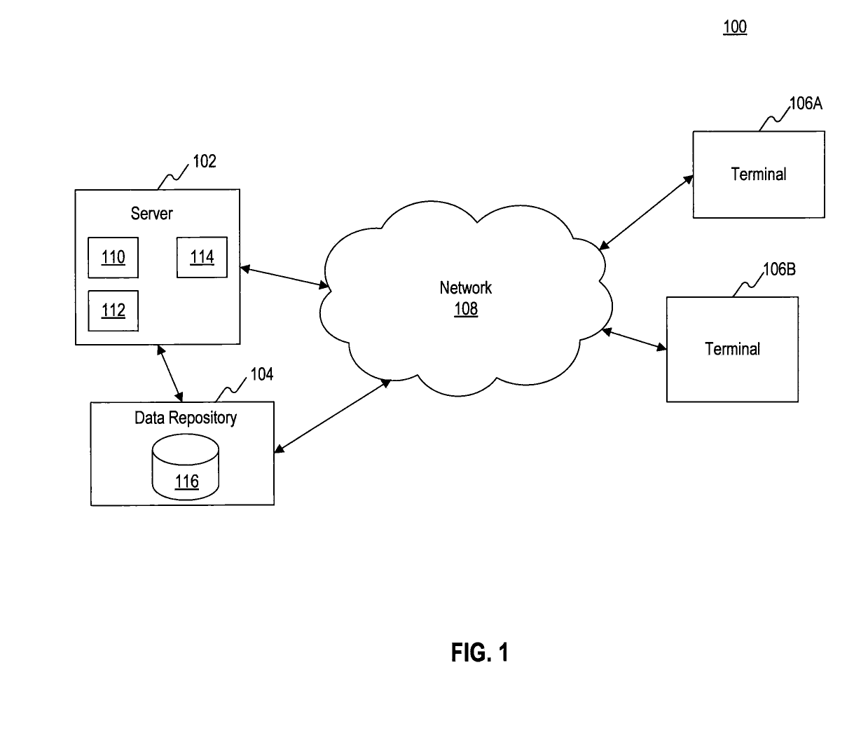

FIG. 1 is an example of a document review system 100 for electronic document review. Document review system 100 may include a server 102, a data repository 104, a terminal 106A, and a terminal 106B, connected via a network 108. Although a specific number of devices are depicted in FIG. 1, any number of these devices may be provided. The functions provided by one or more devices of document review system 100 may be combined. Furthermore, the functionality of any one or more devices of document review system 100 may be implemented by any appropriate computing environment.

Network 108 may provide communication among server 102, data repository 104, terminal 106A, and terminal 106B. Network 108 may be a shared, public, or private network, may encompass a wide area or local area, and may be implemented through any suitable combination of wired and/or wireless communication networks. Furthermore, network 108 may comprise a local area network (LAN), a wide area network (WAN), an intranet, or the Internet.

Server 102 may include a computer (e.g., a personal computer, network computer, server, or mainframe computer). Server 102 may distribute data for parallel processing by one or more additional servers (not shown). Server 102 may also be implemented in a distributed network. Alternatively, server 102 may be a dedicated programmed device. In addition, server 102 may access legacy systems (not shown) via network 108, or may directly access legacy systems, databases, or other network applications. Server 102 may include an output port for outbound communications and an input port for inbound communications. The input port and output port may be combined or separate. Moreover, the input port and output port may be physical ports of logical programmable ports.

Server 102 may include memory 110, at least one processor 112, and database 114. Memory 110 may store data, program instructions, and/or program modules. Program modules may, when executed by processor 112, perform one or more processes related to electronic document review. Memory 110 may include one or more memory devices such as RAM, ROM, magnetic storage, optical storage, removable storage, disk storage, solid state storage, RAID storage, and/or computer-readable media.

Database 114 may store at least one category dictionary. Each category dictionary may include a list of words or phrases that identify a category or theme. The list of words or phrases in the category dictionary may be normalized to be lower case, and may be arranged in alphabetical order. The category dictionaries may be compared with a similarly normalized electronic document in order to identify a category of the corresponding electronic document. This categorization of the electronic document may assist in ordering and/or distribution of the electronic documents for review.

Database 114 may store the category dictionaries for any of the following categories or themes: aggressive tone, abusive tone, passive tone, or geographical areas. A category dictionary of an aggressive tone may include words that indicate anger or aggression. Moreover, a category dictionary of an abusive tone may include words that are insulting or abusive. A category dictionary of a passive tone may include words that are relaxed or passive. A category dictionary of a geographical area may include words that are related to, for example, a particular country, state, city, or any other geographical area. Database 114 may also store category dictionaries for particular topics, such as: accounting, computers, defense/military, engineering, finance, legal, manufacturing, music, politics, science, real estate, and/or sports. Additional themes may include a geographic area and names of corporations. There is theoretically no limit as to the categories or themes reflected by the category dictionaries.

Data repository 104 may include at least one database 116 that stores an electronic document collection and document indices associated with the electronic document collection. Document indices may relate to a document index for fast identification and retrieval of documents from the electronic document collection. Data repository 104 may send and receive data from server 102, terminal 106A, terminal 106B, and/or other devices (not shown) via network 108. Alternatively, data repository 104 may receive data directly from server 102, terminal 106A, terminal 106B, and/or other devices (not shown).

In particular, data repository 104 may send electronic documents from the electronic document collection stored in database 116 to server 102. Server 102 may categorize the electronic documents by comparing the electronic documents with the category dictionaries. Moreover, an administrator of server 102 may select particular category dictionaries for comparison with the electronic documents. Server 102 may organize the electronic documents according to the categorization. Alternatively, server 102 may organize the electronic documents according to any other algorithm or combination of algorithms. Moreover, server 102 may distribute the electronic documents to terminals 106A and 106B, as well as any number of other terminals and/or users, according the categorization.

Although shown as separate entities, server 102 and data repository 104 may be combined. For example, server 102 may include one or more databases in addition to or instead of database 116 in data repository 104.

Terminals 106A and 106B may be any type of device for communicating with server 102 and/or data repository 104 over network 108, or via any other connection. For example, terminals 106A and 106B may include desktop computers, laptop computers, netbooks, handheld devices, mobile phones, or any other computing platform or device. Terminals 106A and 106B may each include a processor (not shown) and a memory (not shown). Furthermore, terminals 106A and 106B may execute program modules that provide one or more graphical user interfaces (GUIs) for interacting with server 102, and/or data repository 104. Terminals 106A and 106B may be used by document reviewers for reviewing electronic documents stored in data repository 104. Terminals 106A and 106B may access the electronic documents via server 102. Server 102 may organize the electronic documents for retrieval by terminals 106A and 106B. Terminals 106A and 106B may send document relevance or review time information as feedback to server 102 or any other device.

Server 102 may receive electronic documents from data repository 104, and may order the electronic documents for document review by users of terminals 106A and 106B. Server 102 may order the electronic documents in a list according to relevancy. For example, electronic documents higher in the list may be more relevant than electronic documents that are lower in the list. Moreover, electronic documents higher in the list may be sent to reviewer(s) before documents lower in the list. In this way, reviewers are more likely to review electronic documents that are relevant earlier in the review process.

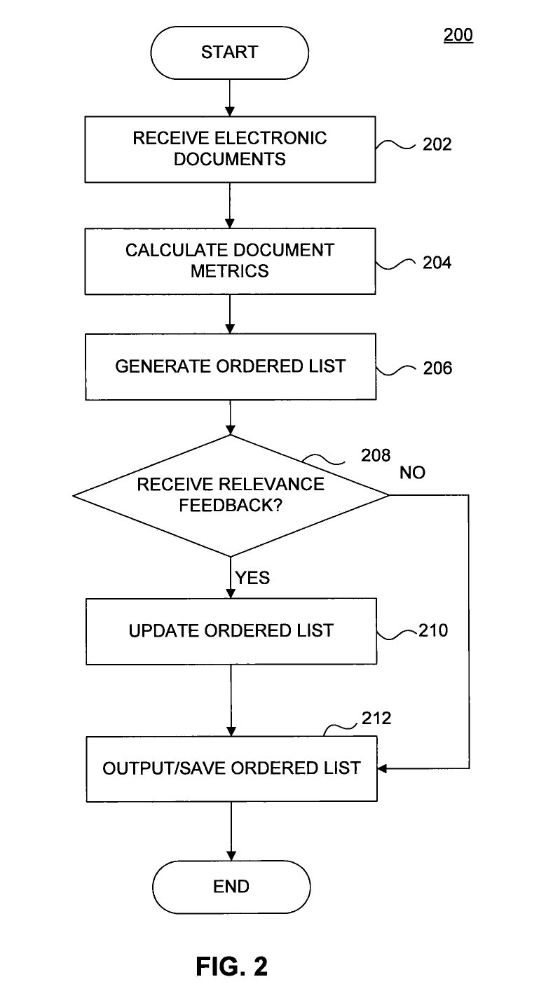

FIG. 2 is a flow diagram of an exemplary process 200, which may be executed by server 102, for ordering the electronic documents. For example, program instructions for process 200 may be stored in memory 110.

At block 202, server 102 may receive electronic documents from data repository 104. For example, the electronic documents may relate to an electronic discovery request of a litigation case.

At block 204, server 102 may calculate document metrics for the received electronic documents. The document metrics may indicate or estimate a relevancy of the electronic documents, so that they may be ordered. An electronic document may be relevant, for example, if it is responsive to a document production request and/or is privileged. The document metrics used to determine relevancy may include a tone, an author, a date range, etc.

A tone of an electronic document may indicate its relevancy. For example, if an electronic document has an aggressive or abusive tone, then it may be of particular relevance or interest in a litigation case. Accordingly, server 102 may determine the tone of the electronic documents by comparing the electronic documents to category dictionaries. In particular, server 102 may store category dictionaries for various tones, such as aggressive and abusive. By comparing category dictionaries of differing tones with the electronic documents, server 102 may determine a tone of the electronic documents.

The author of the electronic document may also be an indicator of relevance. There may be particular individuals who are the objects of a litigation case, and whose communications may be especially relevant. Accordingly, server 102 may take into account the author of an electronic communication when determining relevancy. Similarly, a particular date range may be of particular importance in determining relevancy. Communications during the particular date range may be more likely to include relevant information. Accordingly, server 102 may take into account a date of the electronic document in determining relevancy.

At block 206, server 102 may generate an ordered list of the electronic documents, according the document metrics calculated in step 204. The ordered list may include electronic documents that have not yet been reviewed by one or more reviewers. The electronic documents may be sent to one or more reviewers according to the order of the electronic documents in the list.

The document metrics used to determine relevancy (e.g., the tone, author, or data range) may include signals that indicate a strength, weakness, or absence of the document metric. For example, if server 102 determines that an electronic document belongs to the “aggressive” categorization, the document metric may include a signal indicating the strength of the aggressive categorization; in other words, how “aggressive” the document is. As another example, if server 102 determines that an electronic document is associated with an individual of interest in a case (such as a litigation or other event), the document metric may include a signal indicating the strength of the association with the individual. The strength may be determined, for example, by a number of times that the individual is mentioned in the electronic document. Server 102 may designate these signals, which are related to a strength of document metrics, as independent variables.

A reviewer may review an electronic document, and determine whether or not the electronic document is interesting with respect to the case. Server 102 may designate this factor as a dependent variable. The dependent variable of whether the electronic document is interesting, may be chosen from one of a binary value corresponding to either YES or NO. Alternatively, the dependent variable may be chosen from multiple values, indicating an extent to which the electronic document is interesting.

An electronic document that has been reviewed may provide values that can be plugged in to both the independent variables and the dependent variables. Therefore, multiple electronic documents may each provide a set of dependent variable values and independent variable values. Using a large number of sets of values for independent variables and dependent variables, linear regression may be used to determine a formula that relates the independent variables with the dependent variables. In addition to linear regression, other statistical techniques may be used. In other words, server 102 may use statistical methods to model a relationship between the independent and dependent variables.

Server 102 may then consider an un-reviewed document, which can provide a value to at least one known independent variable expressing a strength of a document metric. However, because the un-reviewed document has yet to be reviewed, server 102 does not know whether or not a reviewer will determine the un-reviewed document to be interesting. Thus, the dependent variable of whether or not the un-reviewed document is interesting, remains unknown. Using the model created when analyzing reviewed electronic documents, server 102 may predict a value of the dependent variable. For example, server 102 may plug in a value for one of the independent variables from the un-reviewed document into the statistical model, and solve for the unknown dependent variable.

Server 102 may calculate the ordered list according to predicted values of “interestingness” for un-reviewed documents. In other words, for un-reviewed documents, server 102 may predict how interesting a reviewer will find the un-reviewed documents, according to the statistical model, and order the un-reviewed documents in the ordered list according to the predicted values.

As discussed, server 102 may use a statistical analysis method to model the relationship between the independent and dependent variables. Statistical analysis methods may include, but are not limited to, regression analysis techniques, neural-network based algorithms, genetic & self-healing algorithms, heuristic algorithms, Markov-Chain optimization, Monte-Carlo simulation, keyword based pruning and optimization methods, and automated partitioning and segmentation. Regression based analysis may include, but is not limited to: linear regression, non-linear regression, step-wise regressions, and logistical regression.

At block 208, server 102 may determine whether it received relevance feedback from at least one document reviewer. Relevance feedback may indicate electronic documents that the reviewer found relevant or interesting based on their document review. If server 102 receives the relevance feedback (208-YES), then process 200 advances to block 210. If server 102 does not receive the relevance feedback (208-NO), then the process 200 advances to block 212.

At block 210, server 102 may update the ordered list based upon the relevance feedback. In particular, electronic documents that have not been reviewed may be similar to documents indicated as relevant by the relevance feedback. Therefore, server 102 may determine that electronic documents that have not been reviewed are relevant, if they are similar to electronic documents that reviewers find relevant. For example, server 102 may determine that two documents are similar to each other if they are both grouped in the same category. Alternatively, server 102 may perform a text comparison to determine whether two documents are similar to each other.

Server 102 may update the document order by including and/or promoting the electronic documents similar to documents already reviewed and indicated as relevant by one or more reviewers in the reviewer feedback. The update may be determined by applying the statistical techniques previously described at block 206, using reviewer feedback as a dependent variable in the modeling. In this way, the modeled relationship between the independent variables and the dependent variables can be continuously updated. Thus, updating the ordered list may be an iterative process, which occurs as reviewer feedback is received. At block 212, server 102 may output or save the ordered list.

Thus, by process 200, server 102 may determine electronic documents that are relevant. These electronic documents may be subsequently sent to a first reviewer for review. If the first reviewer determines that the electronic document is not relevant, then the first reviewer may be incorrect in his or her analysis of the electronic document. In this case, the electronic document may be sent to additional other reviewers, to determine if the other reviewers make the same determination as the first reviewer. If the other reviewers come to a different conclusion than the first reviewer, then the first reviewer may be deemed to have incorrectly classified the electronic document. Moreover, the document may be flagged to determine a future course of action (e.g., an administrator or supervisor may review). Therefore, by process 200, server 102 may identify particular reviewers who frequently misclassify electronic documents as relevant or irrelevant.

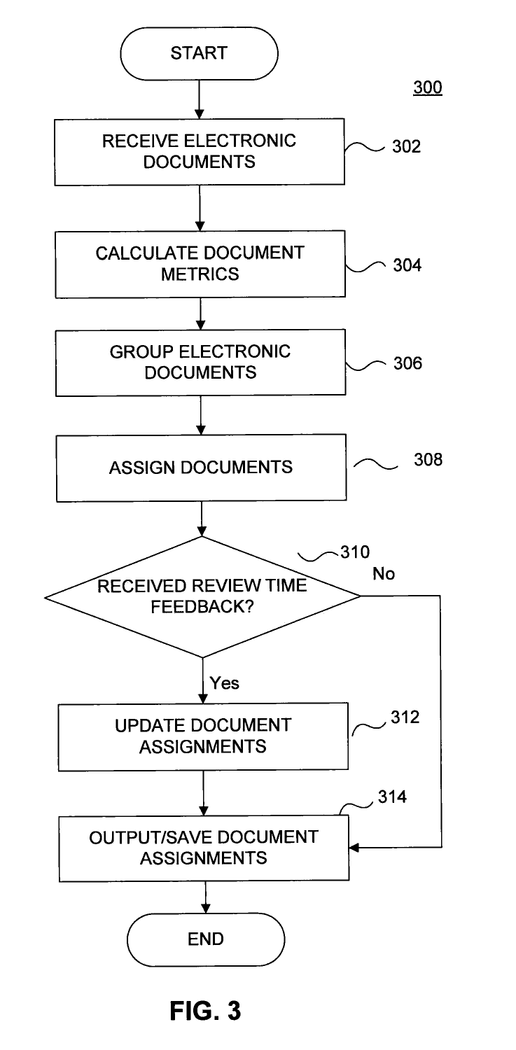

FIG. 3 is a flow diagram of an exemplary process 300 for assigning documents to reviewers for electronic review. Program instructions for process 300 may be stored in, for example, memory 110.

At block 302, server 102 may receive electronic documents of an electronic document collection from data repository 104. At block 304, server 102 may calculate document metrics for the electronic documents. Server 102 may use the document metrics to group the electronic documents, and send the grouped electronic documents to appropriate reviewer(s) according to the grouping.

In particular, server 102 may determine categories for the electronic documents. An administrator of server 102 may activate category dictionaries accessible by server 102. As discussed, the category dictionaries may include a list of words or phrases that reflect and identify a category or theme. Server 102 may compare the electronic documents to the activated category dictionaries. If the comparison yields a similarity between an electronic document and at least one of the category dictionaries, then the electronic document is categorized according to the at least one similar category dictionary. Document metrics may be calculated using techniques other than comparison with category dictionaries, and are not limited in this regard. For example, other document metrics may include: word count, paragraph count, file format, custodian, source, presence of password protection, and any other characteristics of electronic documents. At block 306, server 102 may group together electronic documents. In particular, electronic documents identified as being part of the same category may be grouped together. Alternatively, or additionally, documents with the same custodian or another shared metric may also be grouped together. Moreover, server 102 may group electronic documents that are similar to each other. For example, server 102 may group together electronic documents that are near duplicates of each other, and may send these near duplicates to the same reviewer(s). It may be beneficial to send similar or identical documents to the same reviewer, because the reviewer is already familiar with the subject matter of the similar documents, and can review them quickly. Moreover, it may be beneficial to send the similar or identical electronic documents to the same reviewer at the same time, so that the reviewer can review the similar or identifiable documents all at once. This reduces context switching on behalf of the reviewer, which may slow down the review process.

At block 308, server 102 may assign the grouped electronic documents to one or more document reviewers. The assignments may be done before the reviewers request the electronic documents from server 102. In this way, server 102 may be able to immediately forward the group of electronic documents to the requesting reviewer.

Server 102 may assign groups of electronic documents to reviewers with relevant expertise, experience, or familiarity. For example, server 102 may group together electronic documents categorized according to the subject matter of “finance.” Server 102 may also be aware that particular reviewer(s) have an expertise or familiarity with finance. Accordingly, server 102 may send the documents categorized and grouped as “finance” to reviewers who are experts in finance. It is assumed that reviewers with expertise in finance will review electronic documents categorized as “finance” faster than reviewers who do not have expertise in finance. This is because the electronic documents categorized as “finance” may include technical terms that are easily understood only by those with the appropriate expertise.

For example, in step 310, server 102 may determine whether or not it receives review time feedback from at least one document reviewer. Review time feedback may indicate an amount of time that a reviewer spent reviewing at least one electronic document. For example, the review time feedback may indicate that a first reviewer spent 10 minutes reviewing a group of 50 electronic documents categorized as “finance.” The review time feedback may enable server 102 to determine which reviewers have expertise in a particular area. If a reviewer is particularly fast in reviewing documents of a particular group, then the reviewer may be deemed to have expertise in that particular group. For example, if a second reviewer reviewed a group of 50 electronic documents, categorized as “finance,” in 5 minutes, then server 102 may deem the second reviewer to have more expertise than the first reviewer in electronic documents categorized as “finance.” Alternatively, server 102 may determine expertise of a reviewer by any other means, such as by manual notification by the reviewer.

Alternatively, server 102 may predict how long an electronic document should take to review. In other words, server 102 may estimate how long the average reviewer would take to review a particular electronic document. Server 102 may use document metrics such as document length, word complexity, and document topic to predict how long an electronic document should take to review. Document length may include taking into account a number or words, a number of paragraphs, and/or a number of characters, among other possible factors. If a reviewer consistently reviews documents of a particular topic faster than the predicted average time for review, then server 102 may determine that the reviewer has expertise in that particular topic.

In some embodiments, server 102 may use statistical techniques to determine which electronic documents should be sent to which reviewers. As discussed, document metrics, such as a categorization of an electronic document as relating to “finance,” may include signals that indicate a strength of an association between an electronic document and its corresponding metric. For example, if the electronic document is categorized as being related to “finance,” then a corresponding signal may indicate a strength of this categorization. Some electronic documents may be strongly associated with finance, while others may be moderately or weakly associated with finance. In some embodiments, a percentage may be used to indicate the extent to which an electronic document is related to a topic. Moreover, an electronic document may be related to more than one topic. For example, an electronic document may be 55% similar to finance and 70% similar to computer science. Other document metrics, such as document length, may also be included in the document metrics with associated signals. Server 102 may store the document metrics and signals as independent variables for an electronic document. Signals may also show a negative association between an electronic document and a document metric. For example, if an electronic document is very different from “finance,” then the electronic document may have a negative signal associated with the categorization of “finance.”

Server 102 may also receive the review time feedback for electronic documents that are reviewed. The review time feedback may indicates a length of time that a particular reviewer spent in reviewing a particular electronic document. The length of time that a reviewer spent reviewing a document may be designated as a dependent variable. Thus, the electronic document that has already been reviewed may provide values that may be plugged in to both one or more independent variables as the document metrics and associated signals, and one or more dependent variables as the amount of time it took for the particular reviewer to review the electronic document.

Server 102 may use a statistical analysis to model the relationship between document metrics of an electronic document, and an amount of time that a particular reviewer spends reviewing the electronic document. Server 102 may build these statistical models by analyzing the relationship between document metrics and review time feedback over numerous reviewed electronic documents. Multiple electronic documents that have been reviewed may each provide a set of values for independent variables and dependent variables. Server 102 may apply linear regression, or any other statistical technique, to the sets of values to determine a relationship between the independent variables and the dependent variables. In other words, server 102 may use statistical methods to model a relationship between the independent and dependent variables.

Server 102 may calculate a statistical model for each reviewer. In other words, server 102 may model the relationship between document metrics and review time feedback for each reviewer. This allows server 102 to determine a review profile for each reviewer. When confronted with an un-reviewed electronic document, server 102 may consult the review profiles of different reviewers to determine which reviewer is best suited to review the electronic document. In particular, server 102 may apply document metrics from the electronic document to the statistical model of a reviewer, to predict how long the reviewer would take to review the electronic document.

As discussed, the document assignments may be calculated using a statistical analysis method. Statistical analysis methods may include, but are not limited to, regression analysis techniques, neural-network based algorithms, genetic & self-healing algorithms, heuristic algorithms, Markov-Chain optimization, Monte-Carlo simulation, keyword based pruning and optimization methods, and automated partitioning and segmentation. Regression based analysis may include, but is not limited to: linear regression, non-linear regression, step-wise regressions, and logistical regression. A statistical analysis method may be used individually or in combination with one or more other statistical analysis methods.

If server 102 does not receive review time feedback (310-No), then process 300 advances to block 314. If server 102 does receive review time feedback, then process 300 advances to step 312.

In step 312, the document assignments may be updated based upon the review time feedback. For example, if a reviewer is identified as having expertise in a particular area, then group(s) of electronic documents categorized in that particular area may be sent to the reviewer.

In some embodiments, server 102 may send an electronic document to a reviewer that is predicted to review the electronic document the fastest, in accordance with the statistical modeling discussed above. In particular, server 102 may determine a “relative” efficiency of one reviewer over another, as compared to an absolute efficiency. For example, if server 102 determines that a first reviewer is faster than a second reviewer (“absolute efficiency”), then there may be little benefit to sending an electronic document to the first reviewer. However, if the first reviewer is normally twice as fast as the first reviewer, and is three times as fast when reviewing electronic documents related to finance (“relative efficiency”), then there may be an advantage to routing the electronic document to the first reviewer.

Moreover, the document assignment updates may be calculated using the techniques previously described for the document ordering. The document assignment update may be an iterative process, such that document assignments change as review time feedback is received. In step 314, the assigned documents may be output for review and/or saved. Moreover, the assigned documents may be sent to a reviewer upon receipt of a document distribution command. The document distribution command may be received from a reviewer, or may be internally generated.

The steps in processes 200 and 300 may be performed in any order. Moreover, any of the steps in processes 200 and 300 may be omitted, combined, added, performed concurrently, and/or performed serially. Steps from process 200 may added to process 300 and vice-versa. As such, processes 200 and 300 are exemplary only.

As discussed, it may be beneficial to determine similar electronic documents that are identical or nearly identical to each other. If the similar electronic documents are sent to a single reviewer, that single reviewer may be able to review the similar electronic documents faster than if the similar identical electronic documents are sent to multiple reviewers.

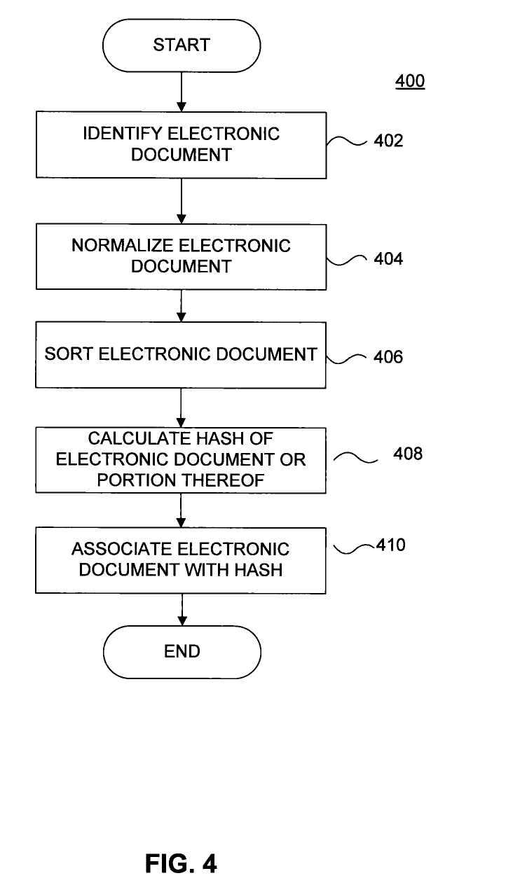

FIG. 4 is a flow diagram of an exemplary process 400 for analyzing an electronic document. Process 400 may be performed on all or some electronic documents in an electronic document collection. Process 400 may analyze electronic documents in order to determine which of the electronic documents are identical or nearly identical. Program instructions for process 400 may be stored in, for example, memory 110. At block 402, server 102 may identify an electronic document. Next, at block 404, server 102 may normalize the electronic document. In particular, server 102 may convert all letters in the electronic document to lowercase. Server 102 may then replace all other non-letter characters with spaces, and may then replace all spaces with line breaks. Server 102 may further replace consecutive line breaks with single breaks. Moreover, server 102 may remove common words such as “a,” “the,” and “is” as well as words that occur frequently in a document collection being normalized. For example, if a group of electronic documents being normalized originate from a particular company, server 102 may remove the company name, because the company name would not assist in categorizing or distinguishing an electronic document in the document collection. Furthermore, server 102 may change a form of groups of words with a similar meaning, into a single word, which may be known as a “token.” In some instances, the token word represents several tenses. For example, the words “cleaning, cleaned, and cleans” may be replaced by the token word “clean.” Words that are similar in meaning, and substantively different in spelling can also be replaced by a token word. For example, the word “scrub” may be replaced by the token word “clean.” In this way, server 102 may normalize the electronic document.

At block 406, server 102 may sort the electronic document. In particular, server 102 may sort the normalized words in the electronic document by alphabetical order. Server 102 may further remove duplicate words.

In block 408, server 102 may calculate a hash value of the normalized and sorted electronic document. Alternatively or in addition, server 102 may calculate a hash value of a portion of a normalized and sorted electronic document. The hash value may be calculated by applying an algorithm or function to every word in the normalized sorted electronic document. The hash value may be considerably smaller in size than the corresponding electronic document. For example, server 102 may use Message-Digest algorithm 5 (MD5) to calculate the hash value. MD5 is a cryptographic hash function. However, any other hash function and/or cryptographic function may be used to create the hash value.

At block 410, server 102 may form an association between the hash value and the electronic document. The association may be in the form of a database record, a pointer, or any other form. Process 400 then ends.

Once process 400 is applied to all or some electronic documents in an electronic document collection, server 102 may determine which of the electronic documents are identical. In particular, server 102 may compare the hash values of different electronic documents with each other. If the hash values of two electronic documents are the same, then the two electronic documents may be identical. Identical documents may be sent to the same reviewer to improve efficiency. In this way, identical electronic documents may be identified, grouped, and sent to the same reviewer.

In some cases, two electronic documents may not be identical, but may be nearly identical. For example, two electronic documents may be the same, except for a few words that are different. However, process 400 groups together documents that are identical. Accordingly, it may be necessary to modify process 400 in order to group together electronic documents that are nearly identical.

In particular, block 408 may be modified so that the hash value of the electronic document is calculated using every Nth word in the normalized sorted electronic document, instead of every word. For example, if N=10, then the hash value is calculated based on words 1, 11, 21, 31, etc, of the normalized sorted electronic document. The greater the value of N implies more tolerance in determining whether two electronic documents are nearly identical. As such, the value N may be adjustable by an administrator.

In some embodiments, portions of electronic documents may be identical or nearly identical. In those situations, hash values may be computed based on the identical or nearly identical portions. The identical or nearly identical portions may be identified according to a splitting technique. For example, in a chain of email correspondences, a portion of an email may quote a previous email. In some embodiments, identical or nearly identical portions of electronic documents, such as a quoted portion of an email, may be highlighted or removed.

The steps in process 400 may be performed in any order. Moreover, any steps in process 400 may be omitted, combined, added, performed concurrently, and/or performed serially. Moreover, other techniques may be used to determine whether documents are identical or nearly identical to each other.

The foregoing description has been presented for purposes of illustration. It is not exhaustive and is not limiting to the precise forms or embodiments disclosed. Modifications and adaptations will be apparent to those skilled in the art from consideration of the specification and practice of the disclosed embodiments. For example, the described implementations include software, but disclosed systems and methods may be implemented as a combination of hardware and software or in hardware alone. Examples of hardware include computing or processing systems, including personal computers, servers, laptops, mainframes, micro-processors and the like. Additionally, although aspects are described as being stored in memory, these aspects can also be stored on other types of computer readable media, such as secondary storage devices, for example, hard disks, floppy disks, CD ROM, or other forms of RAM or ROM.

Computer programs based on the written description and disclosed methods are within the skill of an experienced developer. The various programs or program modules can be created using any of the known techniques or can be designed in connection with existing software. For example, program sections or program modules can be designed in or by means of Java, JavaScript, C++, HTML, XML, or HTML with included Java applets. One or more of such software sections or modules can be integrated into a computer system or existing e-mail or browser software.

Moreover, while illustrative embodiments have been described herein, the scope of the disclosed embodiments includes any and all embodiments having equivalent elements, modifications, omissions, combinations (e.g., of aspects across various embodiments), adaptations and/or alterations as would be appreciated by those in the art based on the present disclosure. Further, the steps of the disclosed methods may be modified in any manner, including by reordering steps and/or inserting or deleting steps.

What is claimed is:

1. A computer-executable method for ordering documents for review in response to an electronic discovery request, the method comprising:
determining, by a processor, one or more metrics of the documents, the one or more metrics indicating at least one of privilege and responsiveness of the documents;
estimating a relevancy of the documents according to the metrics;
ordering the documents from most relevant to least relevant according to the relevancy;
receiving relevance feedback from a first document reviewer;
updating the order according to the relevance feedback; and
sending a first subset of the updated ordered documents to a second document reviewer for review.

2. The method of claim 1, further comprising:
updating the order iteratively after receiving the relevance feedback from the first document reviewer.

3. The method of claim 1, wherein the first document reviewer and the second document reviewer are different.

4. The method of claim 1, further comprising:
receiving the relevance feedback about a reviewed document that was reviewed by the first document reviewer;
determining, from the relevance feedback, that the first document reviewer classified the reviewed document as being responsive;
identifying an un-reviewed document that is related to the reviewed document;
increasing a relevancy of the un-reviewed document because of the relation to the reviewed document classified as responsive; and
updating the order by increasing a position of the un-reviewed document, according to the increased relevancy of the un-reviewed document.

5. The method of claim 1, further comprising:
retrieving a dictionary identifying a category;
comparing the dictionary to at least a portion of the documents to determine a second subset of the documents that are similar to the dictionary;
categorizing the second subset of the documents according to the category of the dictionary, wherein the categorization identifies the metrics of the second subset of the documents;
accessing a statistical model that relates interesting documents to the metrics;
determining, from the statistical model, that the second subset of the documents are interesting; and
updating the order by increasing positions of the second subset of the documents in the list,
wherein the category is indicative of the document relevancy.

6. A system for ordering documents for review in response to an electronic discovery request, the system comprising:
a processor configured to:
determine one or more metrics of the documents, the one or more metrics indicating at least one of privilege and responsiveness of the documents;
estimate a relevancy of the documents according to the metrics; and
order the documents from most relevant to least relevant according to the relevancy;
an input port configured to receive relevance feedback from a first document reviewer, wherein the processor is further configured to update the order according to the relevance feedback; and
an output port configured to send a first subset of the updated ordered documents to a second document reviewer for review.

7. The system of claim 6, wherein the processor is further configured to update the order iteratively after receiving the relevance feedback from the first document reviewer.

8. The system of claim 6, wherein the first document reviewer and the second document reviewer are different.

9. The system of claim 6, wherein the input port is further configured to receive the relevance feedback about a reviewed document that was reviewed by the first document reviewer, and wherein the processor is further configured to:
determine, from the relevance feedback, that the first document reviewer classified the reviewed document as being responsive;
identify an un-reviewed document that is related to the reviewed document;
increase a relevancy of the un-reviewed document because of the relation to the reviewed document classified as responsive; and
update the order by increasing a position of the un-reviewed document, according to the increased relevancy of the un-reviewed document.

10. The system of claim 6, wherein the processor is further configured to:
retrieve a dictionary identifying a category;
compare the dictionary to at least a portion of the documents to determine a second subset of the documents that are similar to the dictionary;
categorizing the second subset of the documents according to the category of the dictionary, wherein the categorization identifies the metrics of the second subset of the documents;
access a statistical model that relates interesting documents to the metrics;
determining, from the statistical model, that the second subset of the documents are interesting; and
update the order by increasing positions of the second subset of the documents in the list;
wherein the category is indicative of the document relevancy.

11. A computer-executable method of assigning an un-reviewed document to a reviewer in response to an electronic discovery request, the method comprising:
identifying first metrics that characterize the un-reviewed document;
receiving feedback from a reviewer about a reviewed document; determining, after receiving the feedback, that the reviewer efficiently reviews documents that are characterized by the first metrics;
assigning, by a processor, the document to the reviewer according to the received feedback; and
sending the document to the assigned reviewer for review based at least on receiving a document distribution command.

12. The method of claim 11, wherein the assigning occurs iteratively while receiving the feedback.

13. The method of claim 11, further comprising
determining, from the feedback, a new time value associated with an amount of time that the reviewer spent reviewing the reviewed document;
accessing a review profile of the reviewer that indicates a relationship between second metrics and review time by the reviewer, wherein the second metrics comprise metrics that characterize a plurality of documents previously reviewed by the reviewer;
updating the review profile of the reviewer with the new time and metrics of the reviewed document;
applying the updated review profile to the un-reviewed document to determine a predicted amount of time for the reviewer to review the un-reviewed document; assigning the un-reviewed document to the reviewer based on the predicted amount of time;
sending the document to the reviewer for review based at least on receiving the document distribution command.

14. The method of claim 11, further comprising
retrieving a dictionary identifying the first category;
comparing the dictionary to the un-reviewed document;
determining, from the comparing, that the document is similar to the dictionary; and
classifying the document according to the first category as a result of the determining, wherein the categorization is part of the first metrics of the document.

15. The method of claim 11, further comprising
generating hash values for a group of electronic documents;
comparing the hash values of the group of electronic documents to determine that similar electronic documents from the group of electronic documents are identical or nearly identical to each other; and
sending the similar electronic documents to a same reviewer.

16. A system for assigning an un-reviewed document to a reviewer in response to an electronic discovery request, the system comprising:
a processor configured to:
identify first metrics that characterize the un-reviewed documents;
an input port configured to receive feedback from a reviewer about a reviewed document, wherein the processor is further configured to determine, after receiving the received feedback, that the reviewer efficiently reviews documents that are characterized by the first metrics, and assign the document to the reviewer according to the received feedback; and
an output port configured to send the document to the assigned reviewer for review based at least on receiving a document distribution command.

17. The system of claim 16, wherein the processor is configured to iteratively assign while receiving the feedback.

18. The system of claim 16, wherein:
the processor is further configured to:
determine, from the feedback, a new time value associated with an amount of time that the reviewer spent reviewing the reviewed document,
access a review profile of the reviewer that indicates a relationship between second metrics and review time by the reviewer, wherein the second metrics comprise metrics that characterize a plurality of documents previously reviewed by the reviewer;
update the review profile of the reviewer with the new time and metrics of the reviewed document;
apply the updated review profile to the un-reviewed document to determine a predicted amount of time for the reviewer to review the un-reviewed document; and
assign the un-reviewed document to the reviewer based on the predicted amount of time;
the output port is further configured to send the document to the reviewer for review based at least on receiving the document distribution command.

19. The system of claim 16, wherein the processor is further configured to:
retrieve a dictionary identifying the first category;
compare the dictionary to the un-reviewed document;
determine, from the comparing, that the document is similar to the dictionary; and
classify the document according to the first category as a result of the determining, wherein the categorization is part of the first metric of the document.

20. The system of claim 16, wherein:
the processor is further configured to:
generate hash values for a group of electronic documents; and
compare the hash values of the group of electronic documents to determine that similar electronic documents from the group of electronic documents are identical or nearly identical to each other; and
the output port is further configured to send the similar electronic documents to a same reviewer.
